(19) United States
(12) Patent Application Publication
(10) Pub. No.: US 2011/0101903 A1
(43) Pub. Date: May 5, 2011

(54) FAN CONTROL SYSTEM

(75) Inventor: YONG-ZHAO HUANG, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/646,873

(22) Filed: Dec. 23, 2009

(30) Foreign Application Priority Data
Oct. 30, 2009 (CN) 200910309142.5

(51) Int. Cl. G05D 23/00

(52) U.S. Cl. 318/472

(57) ABSTRACT

A fan control system includes a temperature detecting circuit and a rotation rate control circuit. The detecting circuit includes an amplifier and a thermal diode. The detecting circuit detects temperature and outputs a voltage signal. The control circuit receives the voltage signal and controls the rotation rate of the fan according to the voltage signal.

### BACKGROUND

1. Technical Field

The present disclosure relates to a control system for a fan.

2. Description of Related Art

With advancements in computer technology, greater demands have been being seen for more power as well as for conserving power. Fans used to dissipate heat can consume a lot of power and even waste power if they are operating faster than needed. Therefore, precise control over fan speed to conserve energy meanwhile ensuring proper heat dissipation is desired.

### BRIEF DESCRIPTION OF THE DRAWINGS

FIG. 1 is a circuit diagram of a first embodiment of a fan control system.

FIG. 2 is a circuit diagram of a second embodiment of a fan control system.

### DETAILED DESCRIPTION

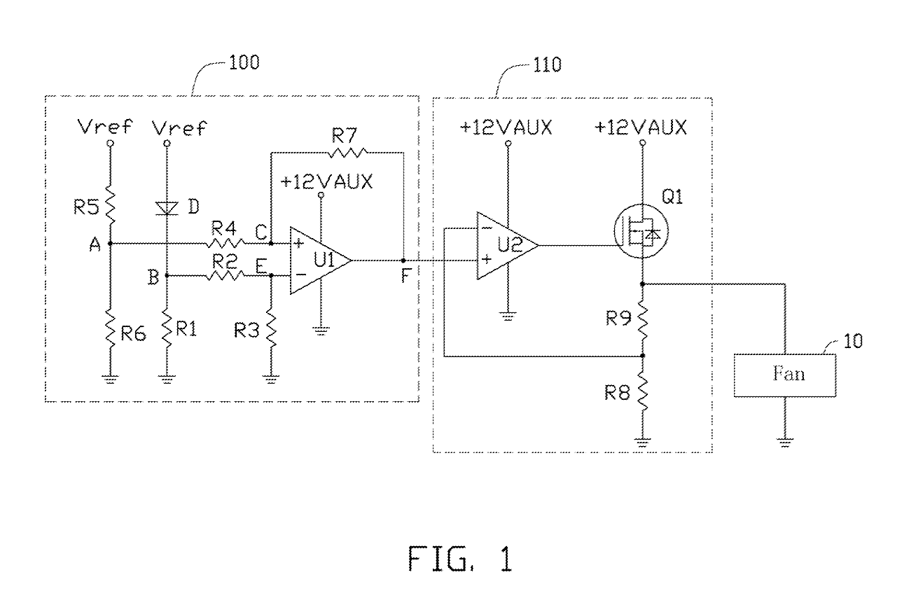

Referring to FIG. 1, a first embodiment of a fan control system for controlling a rotation rate of a fan 10 of an electronic device includes a temperature detecting circuit 100 and a rotation rate control circuit 110.

The detecting circuit 100 is allocated to detect temperature in an enclosure housing the fan 10 of the electronic device, and convert the temperature to a voltage signal. The control circuit 110 receives the voltage signal from the detecting circuit 100, and controls the rotation rate of the fan 10 according to the voltage signal.

The detecting circuit 100 includes a thermal diode D, an amplifier U1, and resistors R1-R7. An anode of the thermal diode D is connected to a reference power Vref. A cathode of the thermal diode D is grounded via the resistor R1, and connected to an inverting terminal of the amplifier U1 via the resistor R2. The inverting terminal of the amplifier U1 is grounded via the resistor R3. A non-inverting terminal of the amplifier U1 is connected to the reference power Vref via the resistors R4 and R5 in series. A node between the resistors R4 and R5 is grounded via the resistor R6. An output terminal of the amplifier U1 is connected to the non-inverting terminal of the amplifier U1 via the resistor R7. A power terminal of the amplifier U1 is connected to a standby power +12VAUX. A ground terminal of the amplifier U1 is grounded.

The controlling circuit 110 includes an amplifier U2, a metal-oxide-semiconductor field effect transistor (MOSFET) Q1, and resistors R8, R9. A non-inverting terminal of the amplifier U2 is connected to the output terminal of the amplifier U1. An inverting terminal of the amplifier U2 is grounded via the resistor R8, and is connected to a source of the MOSFET Q1 via the resistor R9. The output terminal of the amplifier U2 is connected to a gate of the MOSFET Q1. A power terminal of the amplifier U2 is connected to the standby power +12VAUX. A ground terminal of the amplifier U2 is grounded. A drain of the MOSFET Q1 is connected to the standby power +12VAUX. The source of the MOSFET Q1 is connected to the fan 10.

The mechanism by which the fan control system controls rotation of the fan 10 is as follows.

In the figures the node between the resistors R5 and R6 is labeled “A”. A voltage at the node A is marked as Va. A node between the resistors R1 and R2 is labeled “B”. A voltage at the node B is marked as Vb. A node between the resistors R4 and R7 is labeled “C”. A voltage at the node C is marked as Vc. A node between the resistors R2 and R3 is labeled “E”. A voltage at the node E is marked as Ve. The output terminal of the amplifier U1 is labeled “F”. A voltage at the node F is marked as Vf. A current flowing in the resistor R4 is marked as Ir4. A current flowing in the resistor R7 is marked as Ir7.

Based on the characteristics of the thermal diode D, a voltage Vd across the thermal diode D increases when the temperature in the enclosure decreases, and decreases when the temperature in the enclosure increases. In addition, the amplifier U1 and the resistor R7 compose a negative feedback circuit, thus a voltage of the non-inverting terminal is equal to a voltage of the inverting terminal, namely Vc=Ve. A current flowing through the resistor R4 is equal to a current flowing through the resistor R7, namely (Va−Vc)/R4=(Vc−Vf)/R7.

The voltage Vb at the node B can be obtained via a first equation: Vb=Vref−Vd. The voltage Vc at the node C can be obtained via a second equation: Vc=Ve=R3×(Vref−Vd)/(R2+R3). The voltage Va at the node A can be obtained via a third equation: Va=Vref×R6/(R5+R6). The current Ir4 can be obtained by a fourth equation: Ir4=(Va−Vc)/R4. The current Ir7 can be obtained by a fifth equation: Ir7=(Vc−Vf)/R7.

As a result, a sixth equation can be obtained:

Vf=(1+R7/R4)×R3×[(Vref−Vd)/(R2+R3)]−R7×Vref×(R6/R4)×(R5+R6).

From the sixth equation, it can be understood that when the temperature in the enclosure increases, the voltage Vd decreases. As a result, the voltage Vf increases. The amplifier U2 compares the voltage Vf at the output terminal F of the amplifier U1 with a voltage at the inverting terminal of the amplifier U1. Because the voltage Vf at the non-inverting terminal of the amplifier U2 increases, and the voltage at the inverting terminal of the amplifier U1 is stable, a voltage at the output terminal of the amplifier U2 increases. As a result, a voltage at the gate of the MOSFET Q1 increases. The current of the source of the MOSFET Q1 increases accordingly to step up the rotation rate of the fan 10 to decrease the temperature in the enclosure.

When the temperature in the enclosure decreases, the voltage Vd increases. As a result, the voltage Vf decreases. The amplifier U2 compares the voltage Vf at the output terminal F of the amplifier U1 with a voltage at the inverting terminal of the amplifier U2. The voltage at the output terminal of the amplifier U2 decreases. As a result, the voltage at the gate of the MOSFET Q1 decreases. The current of the source of the MOSFET Q1 decreases accordingly to slow down the rotation rate of the fan 10.

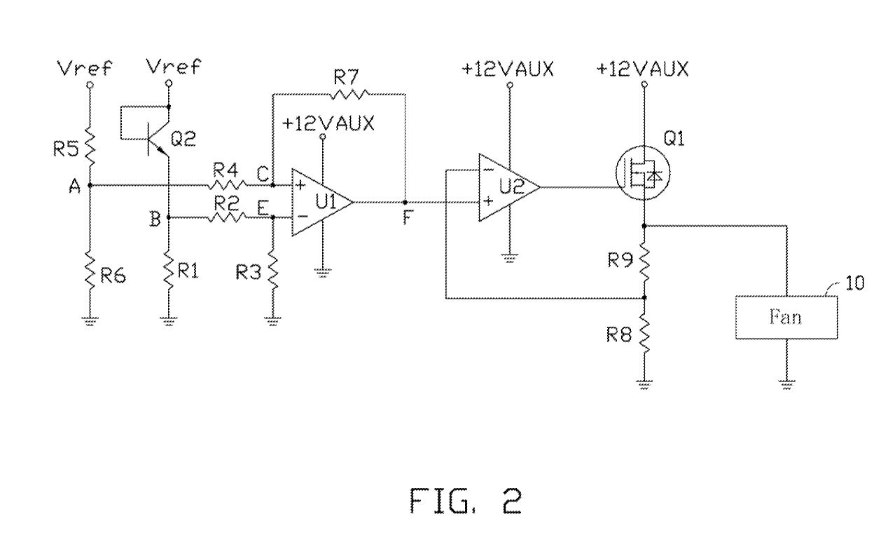

Referring to FIG. 2, a second embodiment of a fan control system for controlling a rotation rate of the fan 10 is shown. The difference between the first and second embodiments is the thermal diode D in the first embodiment is replaced by a transistor Q2 in the second embodiment. An emitter of the transistor Q2 is connected to the node B. A base and a collector of the transistor Q2 are connected to the reference power Vref.

Based on the characteristics of the transistor Q2, a voltage Vbe between the base and emitter of the transistor Q2 increases when the temperature in the enclosure decreases, and the voltage Vbe between the base and emitter of the transistor Q2 decreases when the temperature in the enclosure increases.

With the similar principle of the first embodiment, when the temperature in the enclosure increases, the current of the source of the MOSFET Q1 increases accordingly to step up the rotation rate of the fan 10 to decrease the temperature in the enclosure. When the temperature in the enclosure decreases, the current of the source of the MOSFET Q1 decreases accordingly to slow down the rotation rate of the fan 10.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A fan control system for controlling a rotation rate of a fan, comprising:
a temperature detecting circuit comprising a thermal diode and a first amplifier, wherein an anode of the thermal diode is connected to a first power, a cathode of the thermal diode is grounded via a first resistor and connected to an inverting terminal of the first amplifier via a second resistor, the inverting terminal of the first amplifier is grounded via a third resistor, a non-inverting terminal of the amplifier is connected to the first power via a fourth resistor and a fifth resistor in series, a node between the fourth and fifth resistors is grounded via a sixth resistor, an output terminal of the first amplifier is connected to the non-inverting terminal of the first amplifier via a seventh resistor; and
a rotation rate control circuit comprising a first terminal connected to a second power, a second terminal connected to the output terminal of the first amplifier, and a third terminal connected to the fan, to control the rotation rate of the fan according to a voltage signal at the second terminal.

2. The fan control system of claim 1, wherein the control circuit comprises a second amplifier, and a metal oxide semiconductor field effect transistor (MOSFET), a drain of the MOSFET functions as the first terminal of the control circuit, a source of the MOSFET functions as the third terminal of the control circuit, the source of the MOSFET is grounded via an eighth resistor and a ninth resistor in series, a non-inverting terminal of the second amplifier functions as the second terminal of the control circuit, an inverting terminal of the second amplifier is connected to a node between the eighth and ninth resistors, an output terminal of the second amplifier is connected to a gate of the MOSFET.

3. A fan control system, comprising:
a temperature detecting circuit comprising a first amplifier, and a transistor, wherein a base and a collector of the transistor are connected to a first power, an emitter of the transistor is grounded via a first resistor, and connected to an inverting terminal of the first amplifier via a second resistor, the inverting terminal of the first amplifier is grounded via a third resistor, a non-inverting terminal of the first amplifier is connected to the first power supply via a fourth and fifth resistors in series, a node between the fourth and fifth resistors is grounded via a sixth resistor, an output terminal of the first amplifier is connected to the non-inverting terminal of the first amplifier via a seventh resistor; and
a rotation rate control circuit comprising a first terminal connected to a second power, a second terminal connected to the output terminal of the first amplifier, and a third terminal connected to the fan, to control the rotation rate of the fan according to a voltage signal from the second terminal.

4. The fan control system of claim 3, wherein the control circuit comprises a second amplifier, and a metal oxide semiconductor field effect transistor (MOSFET), a drain of the MOSFET functions as the first terminal of the control circuit, a source of the MOSFET functions as the third terminal of the control circuit, the source of the MOSFET is grounded via an eighth resistor and a ninth resistor in series, a non-inverting terminal of the second amplifier functions as the second terminal of the control circuit, an inverting terminal of the second amplifier is connected to a node between the eighth resistor and the ninth resistor, an output terminal of the second amplifier is connected to a gate of the MOSFET.
